(19) United States
(12) Patent Application Publication
(10) Pub. No.: US 2021/0153689 A1
(43) Pub. Date: May 27, 2021

(54) PORTABLE BURGER PATTY COOKER

(71) Applicant: YONGSHENG HUANG, MARKHAM (CA)

(72) Inventor: YONGSHENG HUANG, MARKHAM (CA)

(21) Appl. No.: 17/092,563

(22) Filed: Nov. 9, 2020

Related U.S. Application Data
(60) Provisional application No. 62/941,671, filed on Nov. 27, 2019.

(51) Int. Cl. A47J 37/06

(52) U.S. Cl. CPC A47J 37/0629; A47J 37/0664

(57) ABSTRACT

The present invention relates to a portable burger patty cooker which is battery powered and can be used to cook burger patty. The present invention provides a compact, lightweight and portable burger patty cooker that doesn't need fire or electrical power. It can be used in any place no matter indoor or outdoor environment. The burger patty cooker is powered by a rechargeable batteries bank. It can set delay cooking time and can cook the burger patty at the set delay time. It is suitable for people to bring it to make burger for lunch either in workplace or another outdoor environment.

### BACKGROUND

### Field of the Invention

The present invention relates to a portable burger patty cooker which is battery powered and can be used to cook burger patty.

### Technical Field

The present invention relates generally to the field of comestibles and more specifically relates to ready to eat portable burger patty cooker.

### Description of the Related Art

U.S. Pat. No. 4,444,094 discloses a conveyor type two-sided cooking apparatus in which the upper platen is power operated to a raised position. A conveyor advances a group of hamburger patties onto the lower platen and stops and the upper cooking platen is then allowed to drop by gravity onto the upper side of the group of patties on the lower platen. Platen stops are provided to control the minimum spacing of the upper platen relative to the lower platen during cooking, to prevent excessive compaction of the cooked patties. After the patties are cooked on both sides, the upper platen is power operated back to its raised position generally paralleling the lower platen and the conveyor is then operated to move the cooked patties off the lower cooking platen. Such conveyor type two-sided cooking apparatus are special purpose machines usable only for cooking certain food products such as hamburger patties that can be advanced by a conveyor onto and off from the lower cooking platen and they are not adapted to alternative use as a single surface grill.

U.S. Pat. No. 4,567,819 relates to a front loading and unloading grill apparatus for two-sided grilling of hamburger patties. The grill apparatus includes upper and lower cooking platens, a patty support panel at the front of the lower cooking platen and an endless conveyor for advancing uncooked patties from the patty support panel onto the lower cooking platen. When the patties are cooked, the conveyor operates in reverse and the cooked patties are discharged to a cooked patty receiver at the front side of the grill apparatus.

Various clamshell type two-sided cooking apparatus have been made in which the upper cooking platen is mounted on a platen support arm for swinging movement about a horizontal axis between a lower cook position and a raised position, and automatically raised at the end of a timed cooking cycle. Some prior art clamshell grills, such as disclosed in U.S. Pat. Nos. 2,009,792; 4,008,067 and 4,165,682, use counterbalance means to assist raising of the upper platen and in U.S. Pat. No. 4,483,239 the upper platen is power operated to a raised position by a pneumatic cylinder at the end of a time cooking cycle. In some prior clamshell grills, the upper platen is pivotally mounted on the platen support arm for tilting movement about a horizontal axis relative to the platen support arm to rest the upper surface of the food products. In U.S. Pat. Nos. 2,632,379 and 4,483,239, the upper platen is rigid with the platen support arm and spacing of the upper platen relative to the lower platen during cooking is effected by vertically adjusting the pivot at the rear of the platen support arm and adjusting an arm stop at the distal end of the platen support arm.

U.S. Pat. No. 4,763,571 is another apparatus for two-sided cooking including a housing upon which is mounted a substantially horizontal lower platen assembly and one or more upper platen assemblies each mounted on respective pivotal support arms for movement between a lowered position and a raised position with respect to the lower platen. The apparatus includes mechanisms for maintaining a predetermined minimum spacing between the upper and lower platens for avoiding undue compaction of food products.

U.S. Pat. No. 4,669,373 is a device to be used in connection with an existing grill to permit two-sided cooking of hamburger patties or the like on a relatively limited basis. The device includes a cooking assembly having an electrically-powered cooking platen which can be selectively positioned on food products on the grill, having been configured for use in conjunction with, and for rocking movement on, commercially-sized restaurant grills.

U.S. Pat. No. 5,197,377 relates to an apparatus for two-sided cooking which comprises one or more upper housing assemblies attached to the rear of a conventional cooking grill to retrofit the grill for two-sided cooking. A plurality of lightweight platens is mounted in the upper housing which float relative thereto, thereby permitting the housing to be lowered to the grill surface so as to completely enclose the items to be cooked.

Various attempts have been made to solve the above-mentioned problems such as those found in U.S. Pat. Nos. 2004/0101603; U.S. Pat. No. 3,532,512; 2008/0254167; U.S. Pat. Nos. 3,607,315; 4,871,560; 2,798,814; and 2008/0014319. This art is representative of seafood comestibles. None of the above inventions and patents, taken either singly or in combination, is seen to describe the invention as claimed.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention is shown in the drawings with the preferred embodiment being shown in FIGS. 1 through 9 inclusive. The portable intelligent burger patty cooker comprises a display unit 11, a lid 10, a tray 30, a burger patty holder 40, a heating board 41, a base housing 20 and a power unit 50.

The display unit 11 is mounted on the top of the lid 10. It is comprised of a display component 13, four key buttons 14 and a housing 18. The four key buttons 14 are START, STOP, UP and DOWN. These key buttons are utilized to input information or instruction by user. The display component 13 and key buttons 14 are constructed on a circuit board. The display unit 11 is connected to the power unit 50 and a temperature sensor 43. The display unit 11 can input information by user and display the delay time.

The lid 10 is made of plastic. It has a hinge connected to the base housing 20 so that the lid 10 can be opened with the hinge as its axis. At the other side from the hinge joint 12 a tab 15 is formed. On the top of the lid 10 a hole 17 is formed. And a lid opening 16 is formed near the hinge joint 12. The electrical wires from the display unit 11 can pass through the hole 17 and the lid opening 16 and connect to the power unit 50.

The tray 30 is located under the lid 10 and is fastened to the lid 10. It is made of Aluminum and coated with non-stick material on the surface. On the top of the tray 30 there is a heating component 31 utilized to generate heat to the tray 30. The heating component 31 is connected to the power unit 50.

The burger patty holder 40 is located in the base housing 20. It is a tray-like shape and made of Aluminum and coated with non-stick material. The burger patty holder 40 is adapted to be placed a burger patty in it. The burger patty holder 40 is removable so that it can be taken out to clean. Under the burger holder 40 is the heating board 41. The heating board 41 is made of Aluminum and fastened to the base housing 20. Under the heating board 41 there are a heating component 42 and a temperature sensor 43 which are mounted at the bottom of the heating board 41. The heating component 42 is connected to the power unit 50. The temperature sensor 43 is connected to the display unit 11. The heating component 42 is utilized to generate heat to the burger patty holder 40. Thus, the burger patty in the burger patty holder 40 can be heated by the burger patty holder 40 and the tray 30. The temperature sensor 43 is utilized to detect the heating board 41 temperature. The display unit 11 receives the signal from the temperature sensor 43 and then control the power output to the heating components 31,43, thereby control the temperature of the heating board 41.

The base housing 20 is container shape and made of plastic. At the top edge it has a hinge connecting to the lid 10. And on the other side of the edge it has a clamp portion 22 which is utilized to fasten the lid 10 to the base housing 20. Near the hinge joint 12 a base opening 21 is formed. The wires from the lid 10 can pass through the base opening 21 and connect to the power unit 50 and the temperature sensor 43.

The power unit 50 is comprised of a power circuit board 52, a socket 23 and a rechargeable batteries bank 51. The power circuit board 52 and the rechargeable batteries bank 51 are mounted on the bottom of the base housing 20. The socket 23 is installed on the sidewall of the base housing 20. The power circuit board 52 is electrically connected to the rechargeable batteries bank 51, the socket 23, the heating components 31,42 and the display unit 11. The rechargeable batteries bank 51 can be charge by an AC adapter plugging in the socket 23.

When using the burger patty cooker, a piece of burger patty is placed in the burger patty holder 40. Set the delay time. And the burger patty cooker will cook the burger patty in the delay setting time. Or if delay time is not set, the burger patty cooker will cook immediately.

Description of Label Number:

| Label | Name | Label | Name |
|---|---|---|---|
| 10 | Lid | 11 | Display Unit |
| 12 | Hinge Joint | 13 | Display Component |
| 14 | Key Buttons | 15 | Tab |
| 16 | Lid Opening | 17 | Hole |
| 18 | Display Housing | | |
| 20 | Base Housing | 21 | Base Opening |
| 22 | Clamping Portion | 23 | Socket |
| 30 | Tray | 31 | Heating Component |
| 40 | Burger Patty Holder | 41 | Heating Board |
| 42 | Heating Component | 43 | Temperature Sensor |
| 50 | Power Unit | 51 | Batteries Bank |
| 52 | Power Circuit Board | | |

Itis a further object of the present invention to provide anew and improved method which is of a reliable system.

This application is for all the age group, targeting all type of peoples and peoples who like to eat fresh burgers & patty.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The invention is a new product. It can be used to cook a burger patty in a convenient way. It is easy to be carried and portable.

In the present technology, burger cooker is a bulky and heavy device and not easy to be carried. The invention is using rechargeable batteries to supply electric power to heat the burger patty. It can be used for people to freshly cook a burger patty and have it with burger bun anywhere.

Currently two methods are used to cook burger patty. One is electrical stove. The other is BBQ grill stove. The electrical stove needs electrical power nearby. In the outdoor environment it is hard to find electrical power. The BBQ grill stove can be used in the outdoor environment. It doesn't need electrical power but it needs fire. It usually is bulky item and hard to carry. Both electrical stove and BBQ grill stove are not suitable for individual to cook burger patty.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

### BRIEF DESCRIPTION OF THE DRAWINGS

FIG. 1 is a front view of the embodiment of present invention.

FIG. 2 is a perspective view of the embodiment of present invention.

FIG. 3 is a perspective view of the open state of the present invention of FIG. 2.

FIG. 4 is an exploded view of the present invention of FIG. 1.

FIG. 5 is an exploded view of the present invention of FIG. 1 from another perspective.

FIG. 6 is a perspective view of the base housing.

FIG. 7 is a perspective view of the lid from bottom.

FIG. 8 is a perspective view of the lid and the display unit.

FIG. 9 a simplified schematic diagram of the circuit connection structure of the present invention.

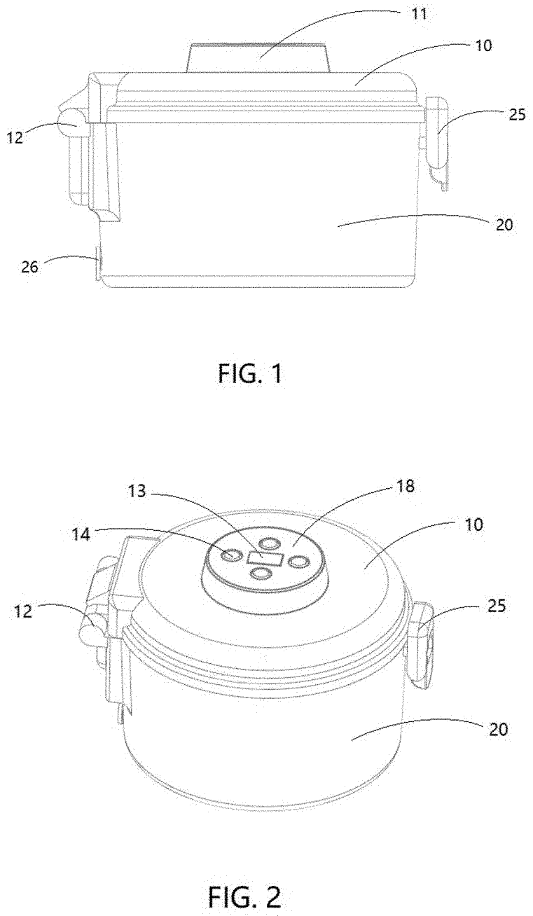

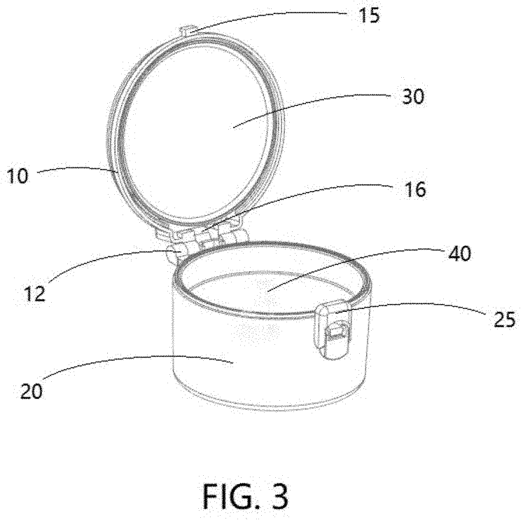

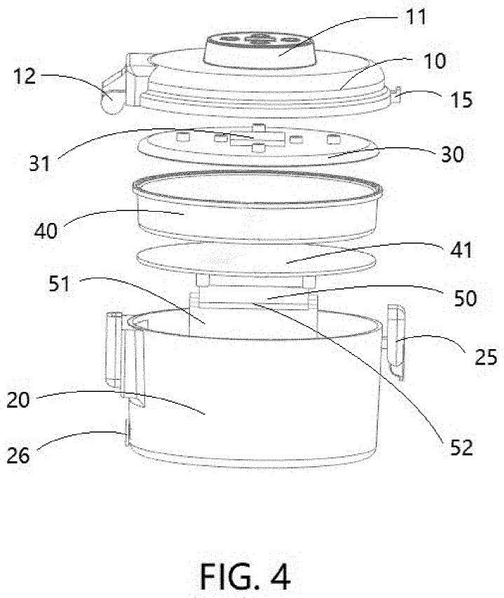

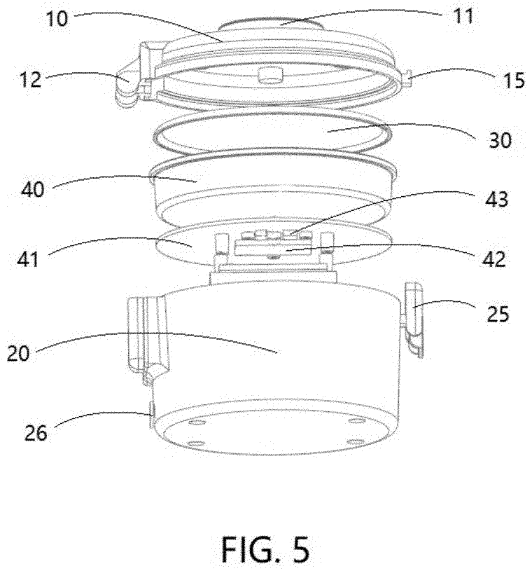

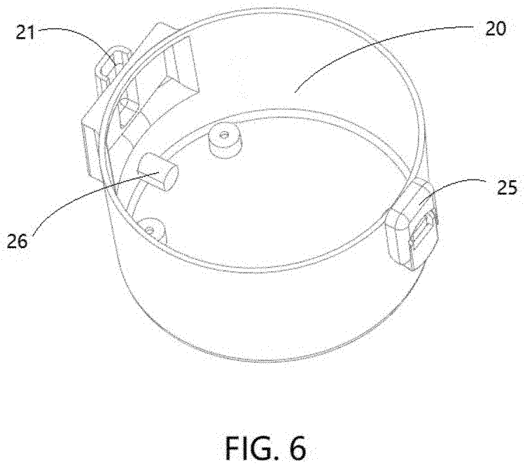

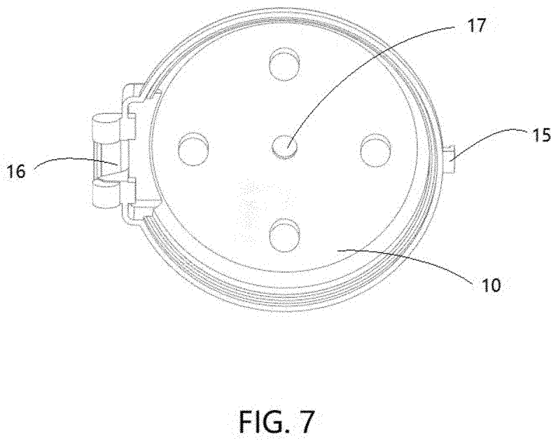

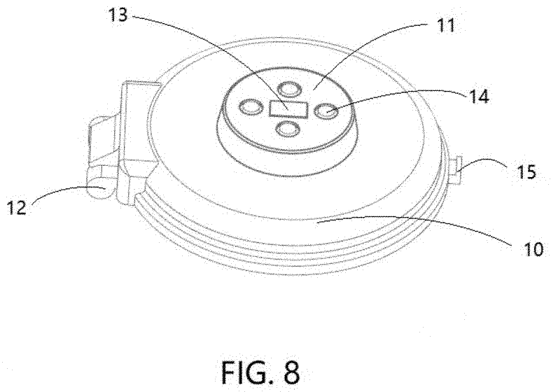

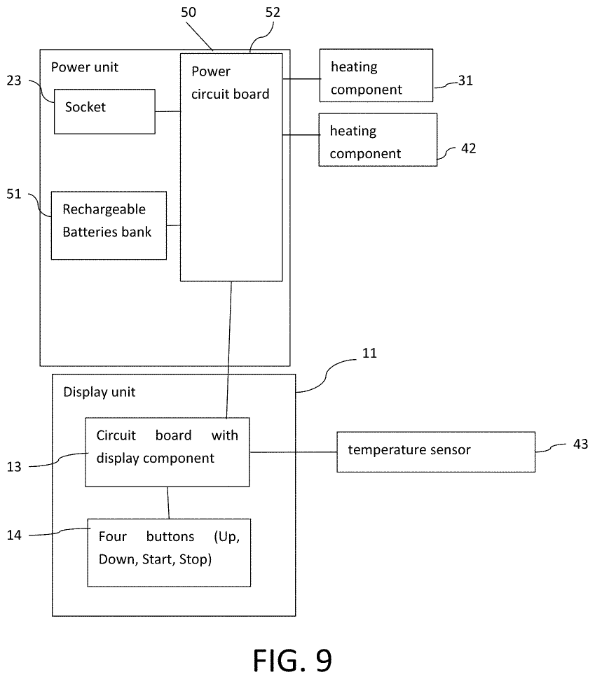

1. A device for effecting cooking of food products comprising:
a portable burger patty;
a Smart battery powered;
a lightweight device;
The ready to eat patties, and burgers system.
